(19) United States
(12) Patent Application Publication
(10) Pub. No.: US 2017/0141455 A1
(43) Pub. Date: May 18, 2017

(54) MOBILE DEVICE

(71) Applicant: Quanta Computer Inc., Taoyuan City (TW)

(72) Inventor: Hui Lin, Taoyuan City (TW)

(21) Appl. No.: 14/985,965

(22) Filed: Dec. 31, 2015

(30) Foreign Application Priority Data
Nov. 18, 2015 (TW) 104138003

(51) Int. Cl. H01Q 1/22; H01Q 13/10

(52) U.S. Cl. CPC H01Q 1/2266; H01Q 13/10

(57) ABSTRACT

A mobile device includes an upper cover, a lower cover, a hinge element, a coupling element, and a feeding element. The upper cover has a first edge. The lower cover has a second edge. The hinge element is coupled between the first edge and the second edge. The coupling element is coupled between the first edge and the second edge. A slit is surrounded by the first edge, the second edge, the hinge element, and the coupling element, so as to form a slot antenna. The feeding element is configured to excite the slot antenna.

### CROSS REFERENCE TO RELATED APPLICATIONS

This Application claims priority of Taiwan Patent Application No. 104138003 filed on Nov. 18, 2015, the entirety of which is incorporated by reference herein.

### BACKGROUND OF THE INVENTION

Field of the Invention

The disclosure generally relates to a mobile device, and more specifically, to a mobile device with a slot antenna.

Description of the Related Art

With the progress of mobile communication technology, mobile devices like portable computers, mobile phones, tablet computers, multimedia players, and other hybrid functional portable electronic devices have become more common. To satisfy the demand from users, mobile devices can usually perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi and Bluetooth systems and using frequency bands of 2.4 GHz, 5.2 GHz, and 5.8 GHz.

In order to improve the appearance, designers often incorporate metal elements into mobile devices. However, the newly added metal elements tend to negatively affect the antennas for wireless communication in mobile devices, thereby degrading the total communication quality of mobile devices. As a result, there is a need to propose a mobile device with a novel antenna structure, so as to overcome the problems of the prior art.

### BRIEF SUMMARY OF THE INVENTION

In a preferred embodiment, the invention is directed to a mobile device including an upper cover, a lower cover, a first hinge element, a first coupling element, and a first feeding element. The upper cover has a first edge. The lower cover has a second edge. The first hinge element is coupled between the first edge and the second edge. The first coupling element is coupled between the first edge and the second edge. A first slit is surrounded by the first edge, the second edge, the first hinge element, and the first coupling element, so as to form a first slot antenna. The first feeding element is configured to excite the first slot antenna.

In some embodiments, the mobile device is a clamshell notebook computer.

In some embodiments, the upper cover, the lower cover, the first hinge element, and the first coupling element are all made of conductive materials.

In some embodiments, the first feeding element is a central conductive line of a coaxial cable, and a conductive housing of the coaxial cable is coupled to the first hinge element.

In some embodiments, the first feeding element is directly connected to the first edge or the second edge, so as to directly excite the first slot antenna.

In some embodiments, the first feeding element extends across the first slit, so as to excite the first slot antenna by mutual coupling.

In some embodiments, the first coupling element is a pogo pin or a metal spring.

In some embodiments, the first coupling element is a capacitive element.

In some embodiments, the first edge further has a first extension portion, and the second edge further has a second extension portion. The capacitive element is formed by the first extension portion and the second extension portion. The spacing between the first extension portion and the second extension portion is shorter than the width of the first slit.

In some embodiments, the mobile device further includes a second hinge element, a second coupling element, and a second feeding element. The second hinge element is coupled between the first edge and the second edge. The second coupling element is coupled between the first edge and the second edge. A second slit is surrounded by the first edge, the second edge, the second hinge element, and the second coupling element, so as to form a second slot antenna. The second feeding element is configured to excite the second slot antenna. The first slot antenna and the second slot antenna cover the same operation frequency band.

### BRIEF DESCRIPTION OF DRAWINGS

The invention can be more fully understood by reading the subsequent detailed description and examples with references made to the accompanying drawings, wherein:

FIG. 1 is a diagram of a mobile device according to an embodiment of the invention;

FIG. 2 is a diagram of a mobile device according to an embodiment of the invention;

FIG. 3 is a diagram of a mobile device according to an embodiment of the invention;

FIG. 4 is a diagram of a mobile device according to an embodiment of the invention;

FIG. 5 is a diagram of S parameters of a first slot antenna of a mobile device according to an embodiment of the invention;

FIG. 6 is a diagram of S parameters of a first slot antenna of a mobile device according to an embodiment of the invention;

FIG. 7 is a diagram of a mobile device according to an embodiment of the invention; and

FIG. 8 is a diagram of S parameters of a first slot antenna and a second slot antenna of a mobile device according to an embodiment of the invention.

### DETAILED DESCRIPTION OF THE INVENTION

In order to illustrate the purposes, features and advantages of the invention, the embodiments and figures of the invention are shown in detail as follows.

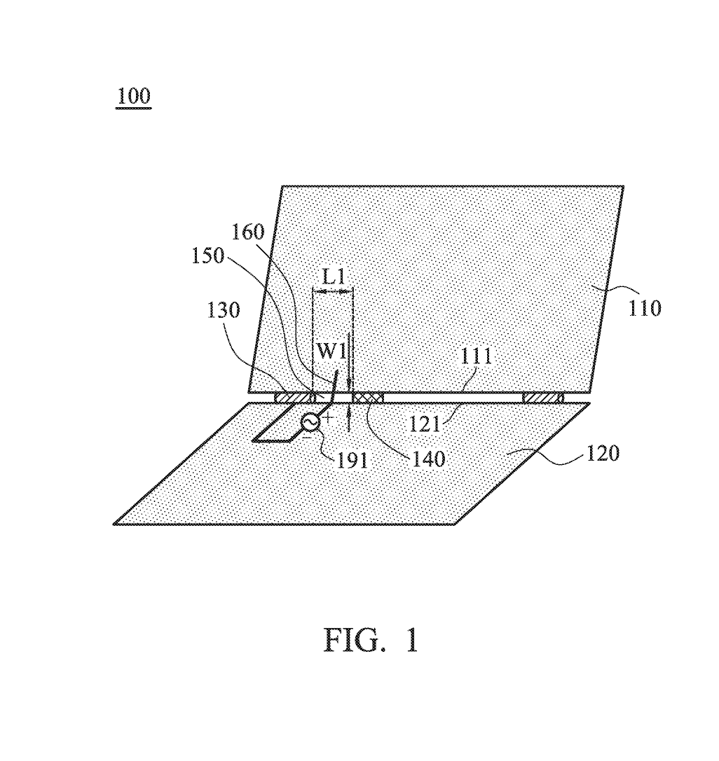

FIG. 1 is a diagram of a mobile device 100 according to an embodiment of the invention. The mobile device 100 may be a clamshell notebook computer. As shown in FIG. 1, the mobile device 100 at least includes an upper cover 110, a lower cover 120, a first hinge element 130, a first coupling element 140, and a first feeding element 160. The upper cover 110, the lower cover 120, the first hinge element 130, and the first coupling element 140 may be all made of conductive materials, such as copper, silver, aluminum, iron, or their alloys. The upper cover 110 may include an A component and a B component of the clamshell notebook computer. A display device may be embedded in the upper cover 110. The lower cover 120 may include a C component and a D component of the clamshell notebook computer. A keyboard may be embedded in the lower cover 120. An angle between the upper cover 110 and the lower cover 120 may be from 0 to 360 degrees. It should be understood that the mobile device 100 may further include other components, such as a processor, a speaker, a battery, a touch control panel, and a storage device.

The upper cover 110 has a first edge 111. The lower cover 120 has a second edge 121. The second edge 121 is opposite to the first edge 111. The first hinge element 130 is coupled between the first edge 111 of the upper cover 110 and the second edge 121 of the lower cover 120. By using the first hinge element 130, the mobile device 100 can operate in an open mode or a closed mode. The first coupling element 140 is directly or indirectly coupled between the first edge 111 of the upper cover 110 and the second edge 121 of the lower cover 120. In a preferred embodiment, a first slit 150 is surrounded by the first edge 111 of the upper cover 110, the second edge 121 of the lower cover 120, the first hinge element 130, and the first coupling element 140, so as to form a first slot antenna. The first feeding element 160 is configured to excite the first slot antenna. The first coupling element 140 provides a current return path for the first slot antenna. The length L1 of the first slit 150 is substantially equal to 0.5 wavelength (λ/2) of a central operation frequency of the first slot antenna. In some embodiments, the first slot antenna operates in a low-frequency band and a high-frequency band. The spacing between the first feeding element 160 and the first hinge element 130 may be substantially equal to 0.25 wavelength of the high-frequency band. The spacing between the first feeding element 160 and the first coupling element 140 may be substantially equal to 0.25 wavelength of the low-frequency band. Specifically, a positive electrode of a first signal source 191 may be coupled to a central conductive line of a coaxial cable, and a negative electrode of the first signal source 191 may be coupled to a conductive housing of the coaxial cable. The first feeding element 160 may be the central conductive line of the coaxial cable. The conductive housing of the coaxial cable may be further coupled to the first hinge element 130. In some embodiments, the first feeding element 160 is directly connected to the first edge 111 of the upper cover 110 or the second edge 121 of the lower cover 120, so as to directly excite the first slot antenna. In alternative embodiments, the first feeding element 160 extends across the first slit 150 (the first feeding element 160 does not touch the upper cover 110 or the lower cover 120), so as to excite the first slot antenna by mutual coupling.

It should be understood that the first hinge element 130 is an indispensable component in the mobile device 100 (e.g., a clamshell notebook computer), and the first slit 150 must exist between the upper cover 110 and the lower cover 120 of the mobile device 100. The invention adds the first coupling element 140 and the first feeding element 160, and therefore the first slit 150 forms a first slot antenna with an appropriate length, so as to cover the desired operation frequency band. The invention need not open a nonconductive antenna window for transmitting electromagnetic waves on the upper cover 110 or the lower cover 120 of the mobile device 100. Accordingly, the mobile device 100 of the invention can enhance the consistency of the whole device appearance. The invention is suitable for application in a variety of mobile devices with whole metal upper and lower covers, and it has the advantages of both improving the device appearance and maintaining the quality of wireless communication.

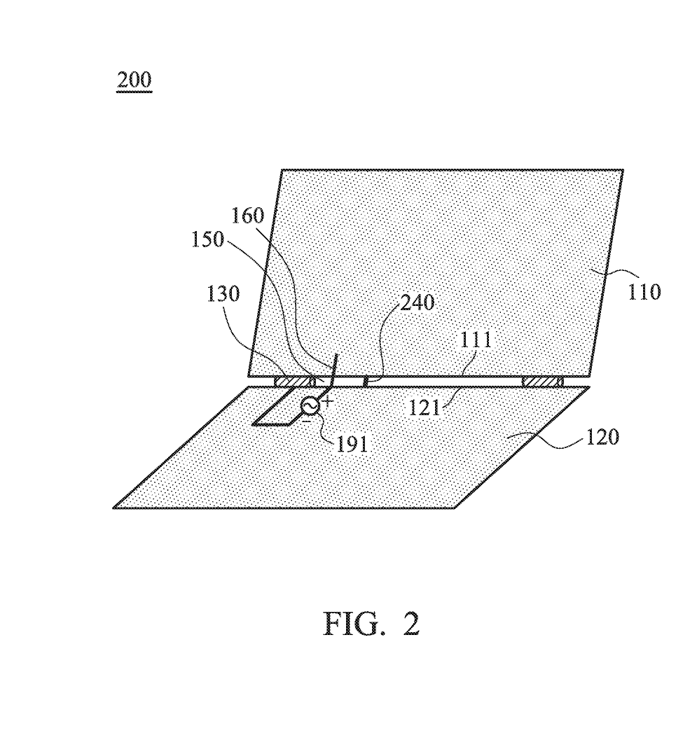

FIG. 2 is a diagram of a mobile device 200 according to an embodiment of the invention. FIG. 2 is similar to FIG. 1. In the embodiment of FIG. 2, a first coupling element 240 of the mobile device 200 is a pogo pin or a metal spring, which is directly connected between the first edge 111 of the upper cover 110 and the second edge 121 of the lower cover 120. Other features of the mobile device 200 of FIG. 2 are similar to those of the mobile device 100 of FIG. 1. Accordingly, the two embodiments can achieve similar levels of performance.

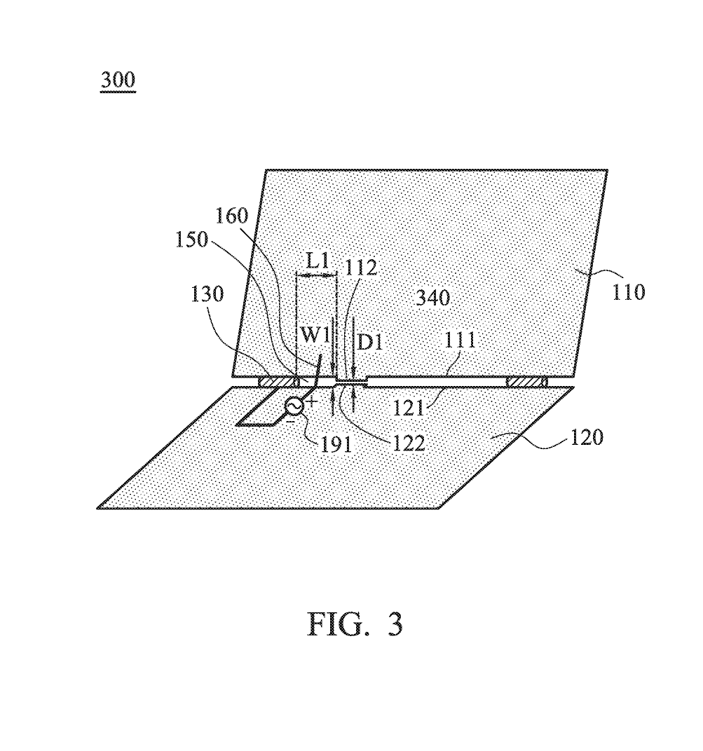

FIG. 3 is a diagram of a mobile device 300 according to an embodiment of the invention. FIG. 3 is similar to FIG. 1. In the embodiment of FIG. 3, a first coupling element 340 of the mobile device 300 is a capacitive element. Specifically, the first edge 111 of the upper cover 110 further has a first extension portion 112, and the second edge 121 of the lower cover 120 further has a second extension portion 122. The first extension portion 112 and the second extension portion 122 are separate from each other, and they extend toward each other. The first coupling element 340 (capacitive element) is formed by the first extension portion 112 and the second extension portion 122. Such a design can omit any additional coupling or capacitive element, and reduce the total manufacturing cost. The spacing D1 between the first extension portion 112 and the second extension portion 122 is shorter than the width W1 of the first slit 150. For example, the width W1 of the first slit 150 may be about 3 mm, and the spacing D1 between the first extension portion 112 and the second extension portion 122 may be about 0.6 mm or less. According to the practical measurement, if a capacitance of the first coupling element 340 increases, the central operation frequency of the first slot antenna will shift to a relatively low-frequency region; and conversely, if the capacitance of the first coupling element 340 decreases, the central operation frequency of the first slot antenna will shift to a relatively high-frequency region. Other features of the mobile device 300 of FIG. 3 are similar to those of the mobile device 100 of FIG. 1. Accordingly, the two embodiments can achieve similar levels of performance.

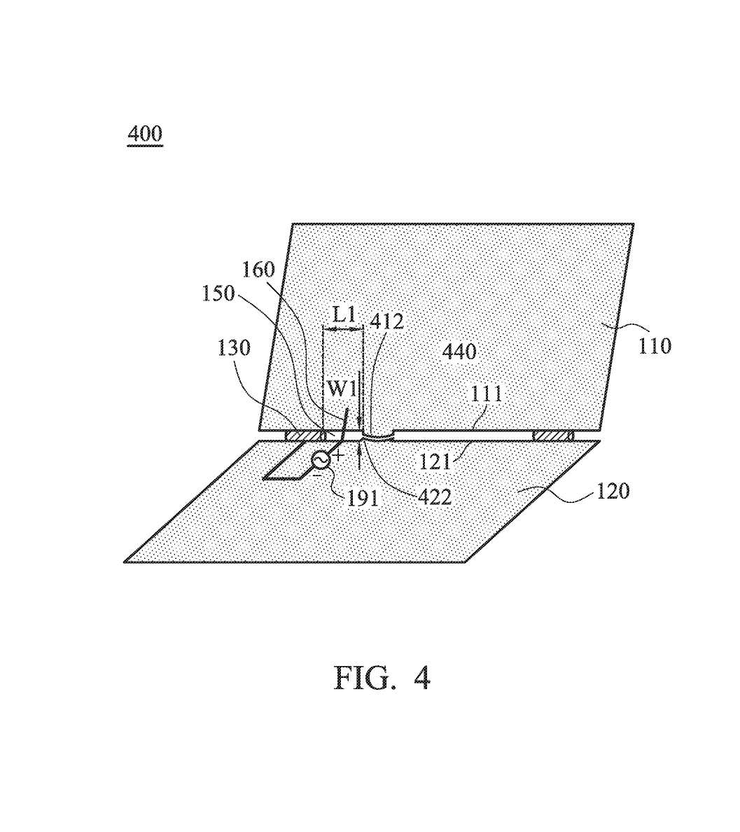

FIG. 4 is a diagram of a mobile device 400 according to an embodiment of the invention. FIG. 4 is similar to FIG. 3. In the embodiment of FIG. 4, a first coupling element 440 of the mobile device 400 is a capacitive element. The first edge 111 of the upper cover 110 further has a first extension portion 412, and the second edge 121 of the lower cover 120 further has a second extension portion 422. The first extension portion 412 and the second extension portion 422 are separate from each other, and they extend toward each other. The first extension portion 412 may have a convex circular-arc shape, and the second extension portion 422 may have a concave circular-arc shape. In alternative embodiments, adjustments are made such that the first extension portion 412 may have a concave circular-arc shape, and the second extension portion 422 may have a convex circular-arc shape. Such a design can increase the design flexibility of coupling element and improve the device appearance. Other features of the mobile device 400 of FIG. 4 are similar to those of the mobile device 300 of FIG. 3. Accordingly, the two embodiments can achieve similar levels of performance.

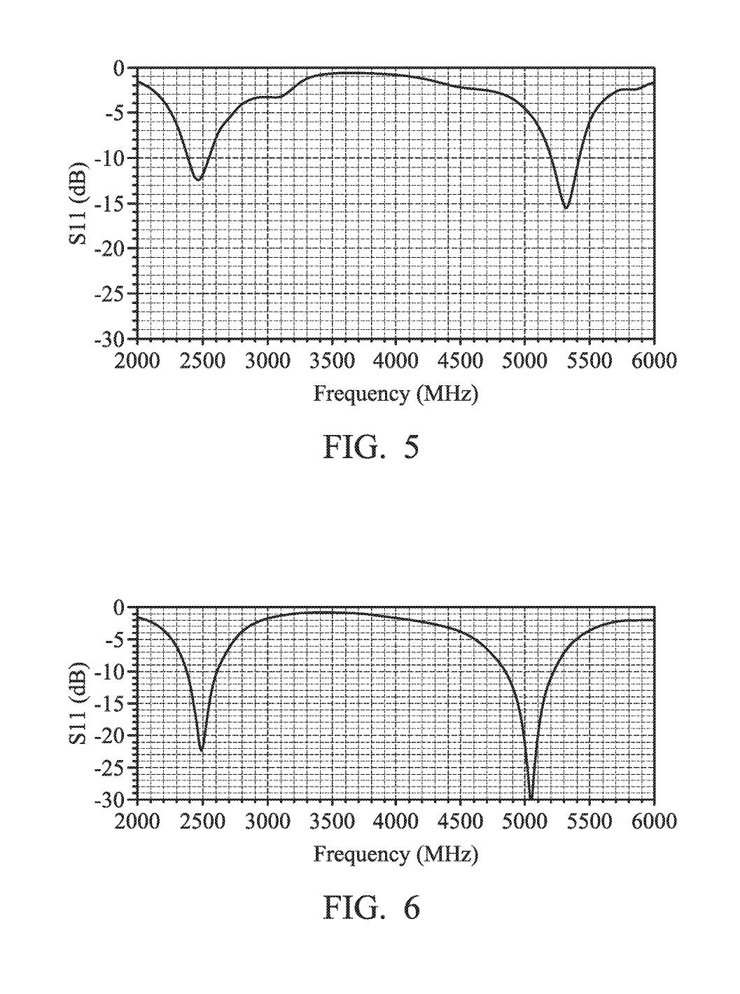

FIG. 5 is a diagram of S parameters of the first slot antenna of the mobile device 200 according to an embodiment of the invention. The horizontal axis represents the operation frequency (MHz), and the vertical axis represents the S11 parameter (dB) (the first slot antenna is set as a first port, i.e., Port 1). As shown in FIG. 5, the mobile device 200, which includes a pogo pin or a metal spring used as the first coupling element 240, can configure its first slot antenna to cover a low-frequency band from 2400 MHz to 2500 MHz, and a high-frequency band from 5150 MHz to 5850 MHz. Therefore, the mobile device 200 can support the dual-band operation of WLAN (Wireless Local Area Networks) 2.4 GHz/5 GHz frequency bands.

FIG. 6 is a diagram of S parameters of the first slot antenna of the mobile device 300 (or 400) according to an embodiment of the invention. The horizontal axis represents the operation frequency (MHz), and the vertical axis represents the S11 parameter (dB) (the first slot antenna is set as a first port, i.e., Port 1). As shown in FIG. 6, the mobile device 300 (or 400), which includes a capacitive element used as the first coupling element 340 (or 440), can configure its first slot antenna to cover a low-frequency band from 2400 MHz to 2500 MHz, and a high-frequency band from 5150 MHz to 5850 MHz. Therefore, the mobile device 300 (or 400) can support the dual-band operation of WLAN 2.4 GHz/5 GHz frequency bands.

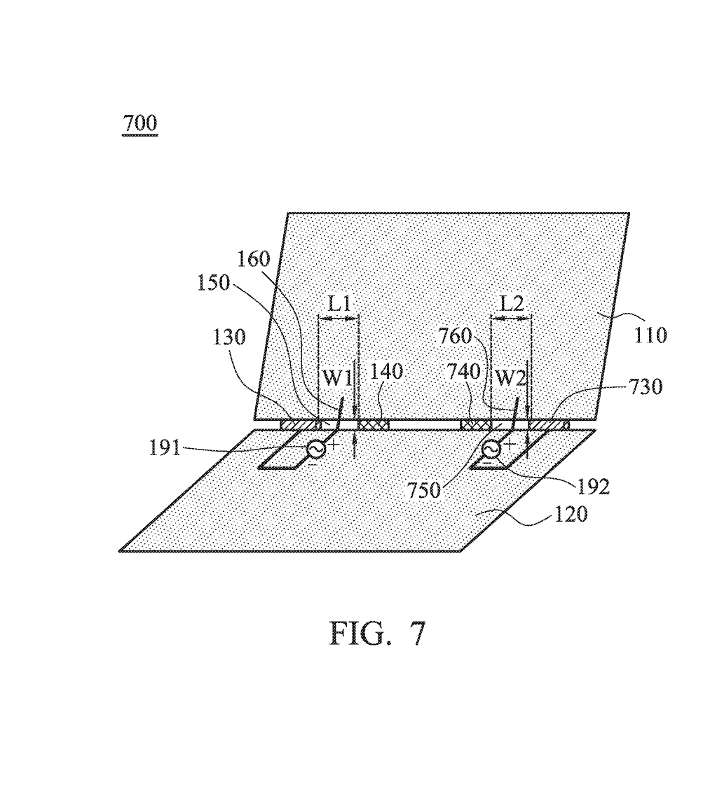

FIG. 7 is a diagram of a mobile device 700 according to an embodiment of the invention. FIG. 7 is similar to FIG. 1. In the embodiment of FIG. 7, the mobile device 700 further includes a second hinge element 730, a second coupling element 740, and a second feeding element 760. The second hinge element 730 and the second coupling element 740 may be both made of conductive materials. The second hinge element 730 are coupled between the first edge 111 of the upper cover 110 and the second edge 121 of the lower cover 120, and it has the same function as that of the first hinge element 130. The second coupling element 740 is directly or indirectly coupled between the first edge 111 of the upper cover 110 and the second edge 121 of the lower cover 120. A second slit 750 is surrounded by the first edge 111 of the upper cover 110, the second edge 121 of the lower cover 120, the second hinge element 730, and the second coupling element 740, so as to form a second slot antenna. The second feeding element 760 is configured to excite the second slot antenna. The second coupling element 740 provides a current return path for the second slot antenna. The length L2 of the second slit 750 is substantially equal to 0.5 wavelength (λ/2) of a central operation frequency of the second slot antenna. In some embodiments, the second slot antenna operates in a low-frequency band and a high-frequency band. The spacing between the second feeding element 760 and the second hinge element 730 may be substantially equal to 0.25 wavelength of the high-frequency band. The spacing between the second feeding element 760 and the second coupling element 740 may be substantially equal to 0.25 wavelength of the low-frequency band. Specifically, a positive electrode of a second signal source 192 may be coupled to a central conductive line of another coaxial cable, and a negative electrode of the second signal source 192 may be coupled to a conductive housing of the coaxial cable. The second feeding element 760 may be the central conductive line of the coaxial cable. The conductive housing of the coaxial cable may be coupled to the second hinge element 730. In some embodiments, the second feeding element 760 is directly connected to the first edge 111 of the upper cover 110 or the second edge 121 of the lower cover 120, so as to directly excite the second slot antenna. In alternative embodiments, the second feeding element 760 extends across the second slit 750 (the second feeding element 760 does not touch the upper cover 110 or the lower cover 120), so as to excite the second slot antenna by mutual coupling. The first slot antenna and the second slot antenna can cover the same operation frequency band. For example, the first slot antenna may be used as a main antenna, and the second slot antenna may be used as an auxiliary antenna, so as to enhance the antenna diversity gain of the mobile device 700. It should be noted that the configurations of the first slot antenna described in the embodiments of FIGS. 2-6 can be applied to the second slot antenna correspondingly, and they will not be illustrated again herein. Other features of the mobile device 700 of FIG. 7 are similar to those of the mobile device 100 of FIG. 1. Accordingly, the two embodiments can achieve similar levels of performance.

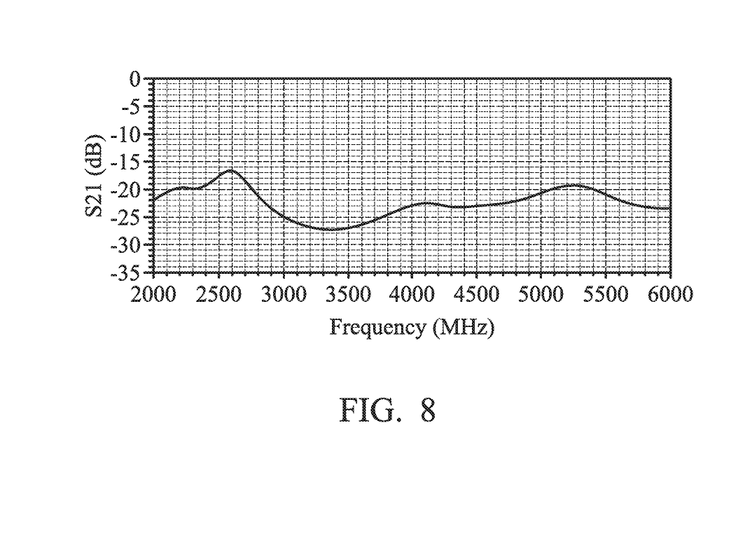

FIG. 8 is a diagram of S parameters of the first slot antenna and the second slot antenna of the mobile device 700 according to an embodiment of the invention. The horizontal axis represents the operation frequency (MHz), and the vertical axis represents the S21 (or S12) parameter (dB) (the first slot antenna is set as a first port, i.e., Port 1, and the second slot antenna is set as a second port, i.e., Port 2). As shown in FIG. 8, within a low-frequency band from 2400 MHz to 2500 MHz and a high-frequency band from 5150 MHz to 5850 MHz, the S21 parameter between the first slot antenna and the second slot antenna can be substantially below −20 dB, meaning that isolation between the first slot antenna and the second slot antenna is good. Even if the first slot antenna and the second slot antenna operate in the same frequency band and are disposed close to each other, the interference therebetween will be still acceptable. In addition, according to practical measurement, if the capacitance of the first coupling element 140 and the capacitance of the second coupling element 740 increase, the isolation between the first slot antenna and the second slot antenna will increase; and conversely, if the capacitance of the first coupling element 140 and the capacitance of the second coupling element 740 decrease, the isolation between the first slot antenna and the second slot antenna will decrease.

Note that the above element sizes, element shapes, and frequency ranges are not limitations of the invention. An antenna engineer can adjust these settings or values according to different requirements. It should be understood that the mobile device and slot antenna of the invention are not limited to the configurations of FIGS. 1-8. The invention may merely include any one or more features of any one or more embodiments of FIGS. 1-8. In other words, not all of the features shown in the figures should be implemented in the mobile device and slot antenna of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
an upper cover, having a first edge;
a lower cover, having a second edge;
a first hinge element, coupled between the first edge and the second edge;
a first coupling element, coupled between the first edge and the second edge, wherein a first slit is surrounded by the first edge, the second edge, the first hinge element, and the first coupling element, so as to form a first slot antenna; and
a first feeding element, configured to excite the first slot antenna.

2. The mobile device as claimed in claim 1, wherein the mobile device is a clamshell notebook computer.

3. The mobile device as claimed in claim 1, wherein the upper cover, the lower cover, the first hinge element, and the first coupling element are all made of conductive materials.

4. The mobile device as claimed in claim 1, wherein the first feeding element is a central conductive line of a coaxial cable, and a conductive housing of the coaxial cable is coupled to the first hinge element.

5. The mobile device as claimed in claim 1, wherein the first feeding element is directly connected to the first edge or the second edge, so as to directly excite the first slot antenna.

6. The mobile device as claimed in claim 1, wherein the first feeding element extends across the first slit, so as to excite the first slot antenna by mutual coupling.

7. The mobile device as claimed in claim 1, wherein the first coupling element is a pogo pin or a metal spring.

8. The mobile device as claimed in claim 1, wherein the first coupling element is a capacitive element.

9. The mobile device as claimed in claim 8, wherein the first edge further has a first extension portion, the second edge further has a second extension portion, the capacitive element is formed by the first extension portion and the second extension portion, and spacing between the first extension portion and the second extension portion is shorter than a width of the first slit.

10. The mobile device as claimed in claim 1, further comprising:
a second hinge element, coupled between the first edge and the second edge;
a second coupling element, coupled between the first edge and the second edge, wherein a second slit is surrounded by the first edge, the second edge, the second hinge element, and the second coupling element, so as to form a second slot antenna; and
a second feeding element, configured to excite the second slot antenna;
wherein the first slot antenna and the second slot antenna cover a same operation frequency band.
